(19) United States
(12) Patent Application Publication
(10) Pub. No.: US 2014/0149738 A1
(43) Pub. Date: May 29, 2014

(54) METHOD FOR ACCESSING A SERVICE OF A SERVICE PROVIDER BY PROVIDING ANONYMOUSLY AN ATTRIBUTE OR A SET OF ATTRIBUTES OF A USER

(71) Applicant: Alain Rhelimi, La Ciotat (FR)

(72) Inventor: Alain Rhelimi, La Ciotat (FR)

(73) Assignee: GEMALTO SA, Meudon (FR)

(21) Appl. No.: 14/130,317

(22) PCT Filed: Jul. 2, 2012
(86) PCT No.: PCT/EP2012/062825

§ 371 Date: Dec. 30, 2013

(30) Foreign Application Priority Data
Jun. 30, 2011 (EP) 11305839.0

(51) Int. Cl. H04L 9/32

(52) U.S. Cl. CPC H04L 9/3263
USPC 713/156

(57) ABSTRACT

(EN)The invention relates to a method Method for accessing a service (S) of a service provider (SP 3) by providing anonymously an attribute or a set of attributes of a user determined and stored in an attribute provider (AP 2), comprising a step of processing pairs of public and private keys (K_{S},K_{P}) of said user in a secure element (SE 1), each public key being used used once and for one set of attributes only for characterised in that it comprises—receiving (S5) by the service provider from the secure element a certificate (C_{AP}K_{P}) delivered by the attribute provider, and a list (LA[^{Y}₀]) of attribute values (A_{Y}) associated to random values (RandomY) in response to a list of attribute requests (L[^{Y}₀]);—determining (S6) by the service provider, digest codes (Di_{Y}) associated to said list (LA[^{Y}₀]) of attribute values (A_{y}) and corresponding random values (Random_{Y}), wherein Di_{Y}=SHA−2 (Random_{y}, A_{Y}),—extracting data (CAL) from said certificate (C_{AP}K_{P}), accessing to said service (S) if said determined digest codes (Di_{Y})are included into said extracted data (CAL).

### FIELD OF THE INVENTION

The present invention relates generally to anonymous and authentic attributes management and more specifically to a method for providing anonymity of a user secure element of attributes

### BACKGROUND OF THE INVENTION

Depending on the service provider, a user or a card holder often has to prove that his profile fulfils different criteria (e.g. age, community belonging, address, status . . . ).

One of the main current problem is to allow the user proving the attributes he has in order to access a service, for example if he is 18 years old or more, his status, address, . . . while protecting his privacy, i.e without disclosing any other information on him than the one required for accessing to the service.

Known methods of the state of the art always disclose some element linked to the card, thus to the card bearer.

The RI mechanism proposed by BSI discloses card specific information. Indeed the card shares an identifier with the service provider and the card being the same one, and then identifier calculated the first time to access the service is also identical.

With a Single sign-on (SSO) mechanism, a single action of user authentication by a unique login/password can replace several authentications, i.e one login/password per access to a service. Authorization can allow a user to access all computers and systems where he has access permission, without the need to enter multiple passwords. SSO uses centralized authentication servers that all other applications and systems use for authentication purposes, and combine this with techniques to ensure that users do not actively have to enter their credentials more than once. Nevertheless user privacy is usually not considered in SSO mechanisms

The document “Security without identification transaction systems to make Big Brother obsolete” by David Chaum proposes that each service provider may know a user by different pseudonyms which are not linkable wherein two organizations cannot combine their databases to build up a file on the user. A user can obtain a credential from one organization using one of his pseudonyms and demonstrate the possession of the credential to another service provider without revealing his first pseudonym to the second service provider. This solution has the same weakness than in RI mechanism, i.e. a same certificate at every connection to the same service provider.

Moreover most of the time the solutions are on-line or use the zero knowledge principle which is traceable.

There is then a need to provide a method for proving compliancy of a user profile stored in a secure element with the profile required by a service provider while preserving the privacy of the user.

Thereto, the present invention provides a method for accessing a service of a service provider by providing anonymously an attribute or a set of attributes of a user determined and stored in an attribute provider, comprising a step of processing pairs of public and private keys keys K_{S},K_{P} of said user in a secure element, each public key being used used once and for one set of attributes only, the method comprising
receiving by the service provider from the secure element a certificate C_{AP}K_{P}, delivered by the attribute provider, and a list of attribute values LA[^{Y}₀] associated to random values Random_{Y} in response to a list of attribute requests L[^{Y}₀];
determining by the service provider, digest codes Di_{Y} associated to said list LA[^{Y}₀] of attribute values A_{Y} and corresponding random values Random_{Y}, wherein Di_{Y}=SHA−2(Random_{Y}, A_{Y}),
extracting data CAL from said certificate C_{AP}K_{P},
accessing to said service if said determined digest codes Di_{Y}are included into said extracted data CAL.

According to other aspects of the invention,

the method may comprise
sending to the attribute provider a list of attributes requests and a set of associated public keys Kₚ[^{N}₀];
determining for each public key Kₚ[^{N}₀] a corresponding certificate C_{AP}K_{P} comprising:
   the public key Kₚ[^{N}₀], and
   data CAL consisting in:
      for each requested attribute, an associated digest code Diₓ, wherein Diₓ=SHA−2(Random_{X}, A_{X}), wherein A_{X} is the attribute value, and Random a random value associated to the attribute value;
   sending back to the secure element said certificate C_{AP}K_{P} and said data CAL;

each public key K_{P}ⁱ may be signed by the attribute provider,

the secure element may send a pseudo certificate of the public key Kₚ[^{N}₀] for the attribute provider;)

the attribute provider may sign a batch of attribute requests and public keys Kp[N0] of the user by the secure element during spare time;)

an identity provider IPS may check the user identity and may sign each public key KPi;

each attribute may have a Uniform Resource Locator to the Attribute Provider Server (URLAPS,), an (UUIDATR) to the attribute in the attributes provider server; a stamp date DATEATR of its update from an attribute provider server;

when the service provider queries the secure element about an attribute, it may also send to the secure element a set of Uniform Resource Identifiers URI of the attributes;)

for each requested attributes received from the service provider, the secure element may determine an obfuscated data UUIDo to the attribute in the attribute provider;

the secure element may determine for each requested attributes, a set of attribute records AR comprising:
the Uniform Resource Identifiers of the attribute URI(A),
the attribute value,
the Uniform Resource Identifier of the Attribute provider server URL_{APS}
the date of the attribute update DATE_{ATR} and
the obfuscated data the Attribute Provider server UUIDo;

the secure element may compute a pseudo certificate CUSi, wherein CUSi=signed[KSi](SHA−2(AR));

the secure element may send the certificate CIPS(KPi) of the public key (KPi) provided by the identity provider service IPS, the pseudo certificate CUSi and the set of attributes records AR to the service provider so as said service provider cheks the authenticity of the attribute records;)

the secure element may operate an attribute synchronization to the Attribute Provider server using the information DATE_{ATR}.

Thanks to the invention, it is advantageously possible to allow the anonymity of any owner of attributes (e.g. age, height, eyes colour, gender, relationship status . . . ). Then user tracking is difficult. An anonymous user can prove the authenticity of attributes to a service provider without providing his identity. All requested attributes are bundled and certified by the attribute provider and are bound to an anonymous/authenticated user.

Thanks to the invention, it is not necessary to be on-line as the invention can be used off-line.

The invention provides advantageously synchronization and date stamping, and allows notification of the service providers when an attribute changes.

The various aspects, features and advantages of the invention will become more fully apparent to those having ordinary skill in the art upon careful consideration of the following Detailed Description, given by way of example thereof, with the accompanying drawing described below:

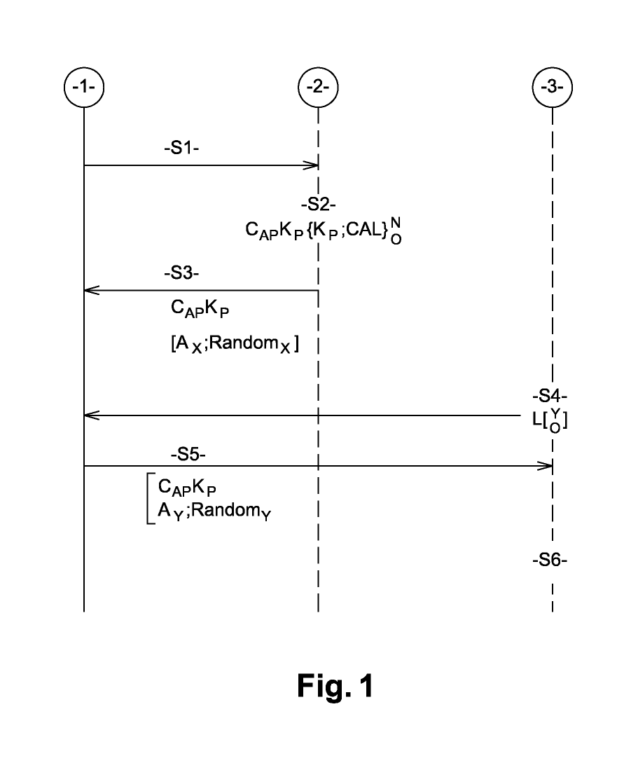

FIG. 1 schematically shows a flowchart diagram according to a first embodiment of the invention.

### DETAILED DESCRIPTION

The present invention may be understood according to the detailed description provided herein.

Shown in FIG. 1 is a flowchart diagram according a first embodiment of the invention between a secure element 1, an attribute provider AP 2 and a service provider SP 3.

The secure element 1 has pre-computed N pairs of key (K_{S},K_{P}) wherein “K_{S}” is a secret key of the user, “K_{P}” is a public key of the user and “i” is an index of a couple of keys (K_{S}ⁱ, K_{P}ⁱ) with 0<i<N. Each K_{P}ⁱ may be signed by the attribute provider AP 2.

Each K_{P}ⁱ is used once and for one set of attributes only. In a step S1, the secure element 1 sends to the attribute provider AP 2 a list of “X” attributes requests A[^{X}₀] and a set of key Kₚ[^{N}₀]. Once received, in a step S2, the attribute provider AP 2 computes a certificate “C_{AP}K_{P}” for each public key “K_{P}” from 0 to N. The certificate “C_{AP}K_{P}” comprises the the public key “K_{P}” and digest codes corresponding to the list of the “X” attributes requests A[^{X}₀], wherein digest codes are defined as following:
for each attribute request A[0 to X], the corresponding digest code Diₓ=SHA−2(Random_{X}, A_{X}). Then the certificate comprises X+1 certified digest codes and form a list called “CAL” in the following specification.

In a step S3, the attribute provider AP 2 returns to the seciure element SE 1 of the user:
the certificate “C_{AP}K_{P}”
for each attribute request A[0 to X], the attribute A_{X}, and its corresponding Random_{X}.

In a step S4, the service provider SP 3 generates a list L[^{Y}₀] of requested attributes and sends the list L to the secure element 1.

The list of the attributes are linked to a single attribute provider otherwise the certificate related to the said list is not valid.

In a step S5, the secure element SE 1 sends back to the service provider SP 3 the certificate “C_{AP}K_{P}” processed in the step S3, which comprises the public key “K_{P}” and digest codes corresponding to the list of the “X” attributes requests A[^{X}₀] combined with a random value Random_{Y}, then there is a digest code per attribute and a global certificate signing all digest codes. The secure element SE 1 also sends for each attribute A[0 to Y, the attributes A_{Y} with the corresponding Random_{Y}. This list is also called LA[^{Y}₀] or “LA” in the following specification.

In a step S6, the service provider SP 3 cheks the certificate C_{AP}K_{P}, and extracts data from the certificate C_{AP}K_{P}.

Extracted data consists in the list of the digest codes Diₓ for each attribute Aₓ and corresponding random Randomₓ.

The service provider SP 3 gets the Random for each attribute A_{Y} from the list “LA” of attributes A_{Y} with the corresponding Random received by the secure element SE 1 in the step S5. Then the service provider SP 3 computes the associated digest codes DI_{Y}=SHA−2(A_{Y},Random_{Y}). The secure element SE 1 then checks that all computed digest codes DI_{Y} are comprised in the list “CAL” of the certified digest codes. The checker has no way to deduce the attribute without the random value Random and the list CAL.

In another embodiment the secure element SE 1 sends a pseudo certificate of the public key “K_{P}ⁱ” for the attribute provider AP if the service provider SP 3 requires the anonymous user authenticity checking. A pseudo certificate has the same structure than a standard certificate but the certificate issuer pays attention to not disclose any constants leading to the disclosure of the identity of the user or the traceability of the user.

According to another embodiment, the attribute provider AP 2 signs a batch of attribute requests and pre-computed public keys of the user by the secure element SE 1 during spare time. The secure element SE 1 uploads a batch of public keys encrypted with the public key or equivalent as a secure and authentic channel of the attribute provider AP 2.

The attribute provider AP 2 notifies the secure element SE 1 of the user when the batch is ready and encrypts the result with the public key the secure element SE 1 of the user or equivalent as a secure and authentic channel. Then the secure element SE 1 downloads the result and decrypts it using its secret key. The above exchanges of data do not require a secure channel of communication.

By doing so, the service provider SP 3 is able to easily check if the public key has been revoked in sending the certificate of K_{P}ⁱ to the attribute provider AP 2. The service provider is able to easily check the authenticity of the attributes and to get a proof of this authenticity. All attributes are bundled and authenticated once per request.

Therefore the user can for example access to a service proposed by the service provider SP 3 anonymously, without disclosing his identity. The user does not need to be on-line for using such method, and it can temporally works off-line.

The method only requires a single certificate verification. It does not require real time performance on the server especially regarding to keys generation. It takes advantage of large capacity of storage of new secure elements and provides a means for authenticate a list of attributes irrespective of their combination in a super set of attributes without disclosing the non requested attributes.

The method is anonymous and non traceable or linkable.

In another embodiment, the user identity is checked by an identity provider IPS and each public key K_{P}ⁱ is signed by the identity provider IPS.

Optionally the user secure element and the service provider operates operate a SSO (Single Sign On). The user is authenticated but still anonymous.

The identity provider operates an SSO only if the secure element is certified so as to check the certificate of the secure element.

The secure element is certified ensuring a full compliancy with the policies related to an attribute container, and each attribute has:

1. an URL_{APS}, a Uniform Resource Locator to the Attribute Provider Server;

2. an UUID_{ATR}, an identifier identifying the attribute in the attributes provider server;

3. a stamp date DATE_{ATR} of its update from an attribute provider server.

When the service provider queries the secure element about an attribute, it sends to the secure element SE 1, a set “SA” of N URI (Uniform Resource Identifier) of the attributes, wherein SA=Setof(URI(A))₀^{N}.

For each requested attributes received from the service provider, the secure element also computes an obfuscated UUIDₒ to the attribute in the Attribute Service Provider as follow:

UUIDₒ=encrypt[K^{p}_{APS}](UUID_{ATR}+Random)

The UUID_{ATR} is padded with a random to make it virtually random in preventing any tracking.

1. For each requested attributes, a set of attribute records “AR” is determined in the secure element SE 1. The set AR comprises: the URI of the attribute URI(A),

2. the attribute value,

3. the URL of the Attribute provider server URL_{APS},

4. date of the attribute update DATE_{ATR} and

5. the obfuscated UUID in the Attribute Provider server UUIDo.

The secure element SE 1 computes a pseudo certificate C_{US}ⁱ, wherein:

C_{US}ⁱ=signed[K_{S}ⁱ(SHA−2(AR))

The secure element SE 1 sends the certificate of the public key K_{P}ⁱ provided by the identity provider service IPS called C_{IPS}(K_{P}ⁱ) in the following specification, the computed pseudo certificate C_{US}ⁱ and the set of attributes records AR to the service provider SE 2. Once received, the service provider SP 3 checks the certificate of K_{P}ⁱ and the certificate of the set of attribute records AR. When the certificates checking is successful then the set of attribute records is considered as authentic. In this embodiment, the service provider SP 3 may subscribe an automatic notification for each attribute using the URL of the attribute and the obfuscated UUIDₒ as parameters.

The secure element can therefore operate an attribute synchronization to the Attribute Provider server using the information DATE_{ATR}.

It advantageously allows synchronization and date stamping. A notification can be send to the service provider SP 3 when an attribute has been modified: it allows automatic notification for attributes changes in guaranteeing the user anonymity. It also allows periodic synchronization between the secure element and the attributes provider servers and allows a proxy server adapting the protocol for transferring attributes between the secure element SE 1 and multiple attribute provider servers using different technologies.

Thanks to the invention, it is possible to disclose authentic attributes in guaranteeing the anonymity of the user. If the service provider is in the circle of confidence of the user, and according to his choice, he may switch the attributes not anonymous or encrypt its identity to reveal it only with trust parties.

1. A method for accessing a service (S) of a service provider (SP 3) by providing anonymously an attribute or a set of attributes of a user determined and stored in an attribute provider (AP 2), comprising a step of processing pairs of public and private keys (K_{S},K_{P}) of said user in a secure element (SE 1), each public key being used once and for one set of attributes only, the method comprising:
receiving (S5) by the service provider from the secure element a certificate (C_{AP}K_{P}) delivered by the attribute provider, and a list (LA[^{Y}₀]) of attribute values (A_{Y}) associated to random values (Random_{Y}) in response to a list of attribute requests (L[^{Y}₀]);
determining (S6) by the service provider, digest codes (Di_{Y}) associated to said list (LA[^{Y}₀]) of attribute values (A_{Y}) and corresponding random values (Random_{Y}), wherein Di_{Y}=SHA−2(Randomy, A_{Y}),
extracting data (CAL) from said certificate (C_{A}pK_{P}),
accessing to said service (S) if said determined digest codes (Di_{Y}) are included into said extracted data (CAL).

2. The method according to claim 1, further comprising:
sending (SI) to the attribute provider (AP 2) a list of attributes requests and a set of associated public keys (Kₚ[^{N}_{O]);}
determining (S2) for each public key (Kₚ[₀]) a corresponding certificate (C_{A}pK_{P}) comprising:
the public key (K_{P}[^{N}₀]), and
data (CAL) consisting in:
for each requested attribute, an associated digest code Di_{X}, wherein Di_{X}=SHA−2(Random_{X}, A_{X}), herein A_{X} is the attribute value, and Random_{X} a random value associated to the attribute value;
sending back (S3) to the secure element (SE 1) said certificate (C_{AP}K_{P})and said data (CAL).

3. The method according to claim 1 or 2, further comprising signing each public key (K_{P}¹) by the attribute provider (AP 2).

4. The method according to claim 1 or 2, further comprising sending by the secure element (SE 1) a pseudo certificate of the public key (K_{P}[^{N}₀]) for the attribute provider.

5. The method according to claim 1 or 2, further comprising signing by the attribute provider (AP 2) a batch of attribute requests and public keys (K_{P}[^{N}₀]) of the user by the secure element (SE 1) during spare time.

6. The method according to claim 1 or 2, further comprising checking by an identity provider IPS the user identity and signing by an identity provider IPS each public key (K_{P}¹).

7. The method according to claim 1 or 2, wherein each attribute has a Uniform Resource Locator to the Attribute Provider Server (URL_{APS}), an (UUID_{ATR}) to the attribute in the attributes provider server; a stamp date (DATE_{ATR}) of its update from an attribute provider server.

8. The method according to claim 7 wherein when the service provider (SP 3) queries the secure element (SE 1) about an attribute, also sending by the service provider (SP 3) to the secure element (SE 1) a set of Uniform Resource Identifiers (URI) of the attributes.

9. The method according to claim 8, wherein for each requested attributes received from the service provider (SP 3), determining by the secure element (SE 1) an obfuscated data (UUIDQ) to the attribute in the attribute provider (AP 2).

10. The method according to claim 8, further comprising determining by the secure element (SE 1) for each requested attributes, a set of attribute records (AR) comprising:
the Uniform Resource Identifiers of the attribute (URI(A),
the attribute value,
the Uniform Resource Identifier of the Attribute provider server (URL_{APS})
the date of the attribute update (DATE_{ATR}) and
the obfuscated data the Attribute Provider server (UUIDo).

11. The method according to claim 10, further comprising computing by the secure element (SE 1) a pseudo certificate (C_{US}¹), wherein C_{US}ⁱ=signed[K_{S}¹](SHA−2(AR)).

12. The method according to claim 11, further comprising sending by the secure element (SE 1) the certificate (C_{IPS}Kp¹)) of the public key (Kp¹) provided by the identity provider service (IPS), the pseudo certificate (C_{US}¹) and the set of attributes records (AR) to the service provider (SP 3) so as said service provider checks the authenticity of the attribute records.

13. The method according to claims 10, wherein the secure element operates an attribute synchronization to the Attribute Provider server using the information DATE_{ATR}.
